(19) United States
(12) Patent Application Publication
(10) Pub. No.: US 2024/0058829 A1
(43) Pub. Date: Feb. 22, 2024

(54) ONE-TOUCH MAKEUP REMOVER PUMP HEAD

(71) Applicant: ZHEJIANG UKPACK PACKAGING CO., LTD., Yuyao City (CN)

(72) Inventor: Shunjin JI, Yuyao City (CN)

(73) Assignee: ZHEJIANG UKPACK PACKAGING CO., LTD., Yuyao City (CN)

(21) Appl. No.: 18/201,311

(22) Filed: May 24, 2023

(30) Foreign Application Priority Data
Aug. 18, 2022 (CN) 202210995631.6

(51) Int. Cl. B05B 11/10

(52) U.S. Cl. CPC B05B 11/1001; B05B 11/1059

(57) ABSTRACT

In a one-button makeup remover pump, the top sides of the bottle cap are symmetrically provided with protruded snap-in edges, the button slot on one side of the cap between the snap-in edges is provided with a button, the snap-in edges of the cap are snapped to the corresponding rim edge of the flip cover, the cap on the other symmetrical side of the button is provided with a flip cover hingedly fixed to the bottle cap, an elastic strip is disposed between the flip cover and the bottle cap at the hinged joint, and both ends of the elastic strip are molded in one piece with the bottle cap and the flip cover of the bottle cap respectively. An elastic contact of the button is set against the elastic strip of the bottle cap, and the flip of the bottle cap pops open.

### TECHNICAL FIELD

The present invention relates to the makeup remover pump head, or specifically, one-touch make-up remover pump head.

### BACKGROUND ART

The make-up remover pump is one of the lotion pumps, generally comprising the pump head and the bottle, and is one of the containers for liquid cream cosmetic products. Pushing down the nozzle of the lotion pump, the liquid cream lotion will flow out of the container. How it works: pushing down the nozzle, the cap will move and cause the volume in the bottle to expand and shrink in cycles, and the liquid pressure will increase and thus draw out the liquid in bottle. Some make-up remover pumps available on the market come with anteriorly protruded disc structure on top, pressing down the disc, then liquid will flow out of the liquid outlet that is disposed in the middle of the disc, e.g.: the patent as disclosed in Chinese patent literature under the Patent Application Number: 201720902071.X, Date of Publication: 8 May 2018, Title of Utility Model Patent “A pump head mechanism and push-down makeup remover container”; another patent as disclosed in Chinese patent literature under the Patent Application Number: 201821078467.8, Date of Publication: 26 Mar. 2019, Title of Utility Model Patent “A makeup remover pump structure”; another patent as disclosed in Chinese patent literature under the Patent Application Number: 202120484978.5, Date of Publication: 24 Dec. 2021, Title of Utility Model Patent “A pump head for makeup remover push-down dispenser”. However, the flip cover and the bottle cap as parts of the above-mentioned products and similar products are molded in one-piece, but the side of the bottle cap is not designed with the button structure. As a consequence, the prior-use safety of similar products is poor, liquid is likely to dispense out due to vibration or other means by chance.

### SUMMARY OF INVENTION

To overcome the deficiencies as stated above, the present invention is intended to provide a one-button makeup remover pump, to the extent that the absence of button on the bottle cap structure disposed with a flip cover in existing similar products, and certain technical issues including single form of button structure, inconvenient use and assembly, unavailable recycling and reuse, and poor eco-friendly property would be resolved. These aims can be realized by the following technical alternatives.

A one-touch makeup remover pump head, an inner threaded ring is provided at the bottom of the bottle cap, a pump outlet ring is disposed on the inner side of the inner threaded ring of the bottle pump, a clasp of the pump body is fixed to the pump outlet ring of the pump body, the stem extending from the pump body is snap-fit to the stem sleeve disposed at the bottom of the pressing plate cap, an anti-release plug is disposed on the orifice at the top of the pressing plate cap, liquid flows out through the orifice at the anti-release plug disposed on top of the pressure plate cap, the pump core assembly comprises the pump body, the stem, the plastic ball bead, the inner plug, the piston, the valve pin and the spring; as the essential point of the structural design, the top sides of the bottle cap are symmetrically provided with protruded snap-in edges, the button slot on one side of the cap between the snap-in edges is provided with a button, the snap-in edges of the cap are snapped to the corresponding rim edge of the flip cover, the cap on the other symmetrical side of the button is provided with a flip cover hingedly fixed to the bottle cap, an elastic strip is disposed between the flip cover and the bottle cap at the hinged joint, and both ends of the elastic strip are molded in one piece with the bottle cap and the flip cover of the bottle cap respectively; the elastic hole of the button passes through the outer diameter of the inner threaded ring at the bottom of the bottle cap, with one end of the button fit into the button slot on one side of the bottle cap, and the elastic contact of the other end extended from the button slot and symmetrical with respect to the opening slot of the bottle cap, where the elastic slot of the button is aligned with the elastic strip; the elastic hole of the button is larger than the outer diameter of the inner threaded ring of the bottle cap, the elastic contact of the button is set against the elastic strip of the bottle cap, and the flip of the bottle cap pops open. When pushing down, the button would be subject to deformation or displacement, such that the elastic contact of the button has one end set against the elastic strip disposed between the flip cover and the bottle cap, the snap-in position between the flip cover and the bottle cap is forced to displace or disengage, the flip cover can pop open from the bottle cap.

Disconnected strap ribs are disposed on both sides of the opening slot where flip cover of the bottle cap is hinged and fixed, the flip cover that is symmetrical to the opening slot is provided with an opening side slot, both ends of the elastic strip of the bottle cap are molded in one piece with the bottle cap and the flip cover of the bottle cap through the bottom of the opening slot, the bottom of the side slot respectively, and the strap ribs are molded in one piece with the bottle cap. The structural form of one-piece molded flip cover and bottle cap is described above, an alternative is other existing pin-type hinges, but the elastic strip molded in one piece with the flip cover and the bottle cap is considered simple and believed to be the best solution.

The button is provided with equally spaced protruded ribs inside the elastic hole of the button, a protruded locating rib is disposed in the middle on top of the elastic contact of the button, the upper and lower edges of the curved side of the button symmetrically on the other side of the elastic contact are protruded above the elastic hole of the button respectively, the locating rib at the elastic contact of the button is inserted into the locating slot at the opening groove. The above structure permits the stable use of the elastic contact of the button at one end and ensures a larger push-down area on the other side.

A clasp hole is disposed on top of the button, the opening inside the flip cover of the bottle cap to which the clasp hole corresponds is provided with a snap-in clasp, and the snap-in clasp of the flip cover engages with the snap-in hole of the button. The above structure enhances the snap-in securing between the flip cover and the button.

A protruded snap-in lip is disposed on top of the button, the snap-in lip transits from bottom to the outer side of the top which is protruded and molded in one piece, the opening inside the flip cover of the bottle cap to which the protruded snap-in lip corresponds is provided with a protruded snap-in rib, the snap-in rib of the flip cover engages with the snap-in lip of the button. The above structure also allows for the snap-in securing between the flip cover and the button.

The snap-in lip of the button is provided with the clasp hole, a lower clasp is disposed on the edge of the snap-in lip above the clasp hole, the opening inside the flip cover of the bottle cap to which the lower clasp corresponds is provided with the upper clasp, and the upper clasp of the flip cover engages with the clasp hole of the button. Another alternative of snap-in securing structure between the flip cover and the button is described above.

A locking knob is disposed at the button slot side of the bottle cap, the slide hooks on the upper and lower edges of the locking knob are fastened to the slide slot on the button slot side of the bottle cap, and the locking head on the locking knob side is inserted into the locking hole on the button side of the bottle cap.

The spring in the pump body is a metal spring, the outer diameter of the plug gap on top of the inner plug is fastened to the inner diameter of the pump outlet of the pump body, the metal spring is disposed on the inner side of the inner plug with one end set against the bottom of the spring cavity in the inner plug, and the other end set against the spring rib of the outer diameter of the stem. The stem has one end extended from the inner plug and the pump body and the other end fastened in one-piece to the valve pin in the pump body, a piston is disposed at the snap-in joint, the stem and the pin at the snap-in joint are disposed with accessible liquid pathways respectively, the outer diameter of the piston sealed against the inner wall of the pump body, a plastic ball bead is fastened to the inlet hole of the pump body underneath the valve pin, and a dip tube is inserted at the bottom of the inner hole of the pump body. The particular structural embodiment of the pump core assembly is described above.

The metal spring is replaced by a spiral one-piece plastic spring. The above structure facilitates the overall recycling and reuse of the makeup remover pump head.

The present invention features a reasonable structure, convenient assembly and use and in particular, various forms of snap-in structures between the flip cover and the bottle cap. The use in conjunction with the plastic spring structure in the pump body facilitates its overall recycling and reuse; it can be suitably used as one-touch makeup remover pump head, or the structural modification of similar products.

### BRIEF DESCRIPTION OF THE DRAWINGS

FIG. 1 is the schematic diagram of the exploded structure of the first embodiment of the present invention, in which the framed part is the schematic diagram of the bottom structure of the button.

FIG. 2 is the schematic diagram of the use state of FIG. 1.

FIG. 3 is the schematic cross-section diagram of the closed state of FIG. 2, with the arrow showing the direction of pushing down the button.

FIG. 4 is the schematic cross-section diagram of the open state of the second embodiment of the present invention, with the dashed line showing the pump core assembly.

FIG. 5 is the schematic three-dimensional diagram of the lock button opening in the open state of the third embodiment of the present invention.

FIG. 6 is the schematic three-dimensional diagram of the open state of the fourth embodiment of the present invention, with the framed part of the diagram enlarged and the button push-down.

FIG. 7 is the schematic cross-section diagram of the closed state of FIG. 6, in which the metal spring is replaced by a plastic spring.

Serial numbers and names of the accompanying drawings: 1. Cap, 101. Snap-in edge, 102. Elastic strip, 103. Snap-in clasp, 104. Snap-in rib, 2. Pressing plate cap, 3. Anti-release plug, 4. Button, 401. Elastic hole, 402. Elastic contact, 403. Snap-in hook hole, 404. Snap-in lip, 5. Gasket, 6. Plastic ball bead, 7. Pump body, 8. Dip tube, 9. Stem, 10. Inner plug 11. Piston, 12. Valve pin, 13. Metal spring, 14. Locking knob, 15. Plastic spring

### Embodiments

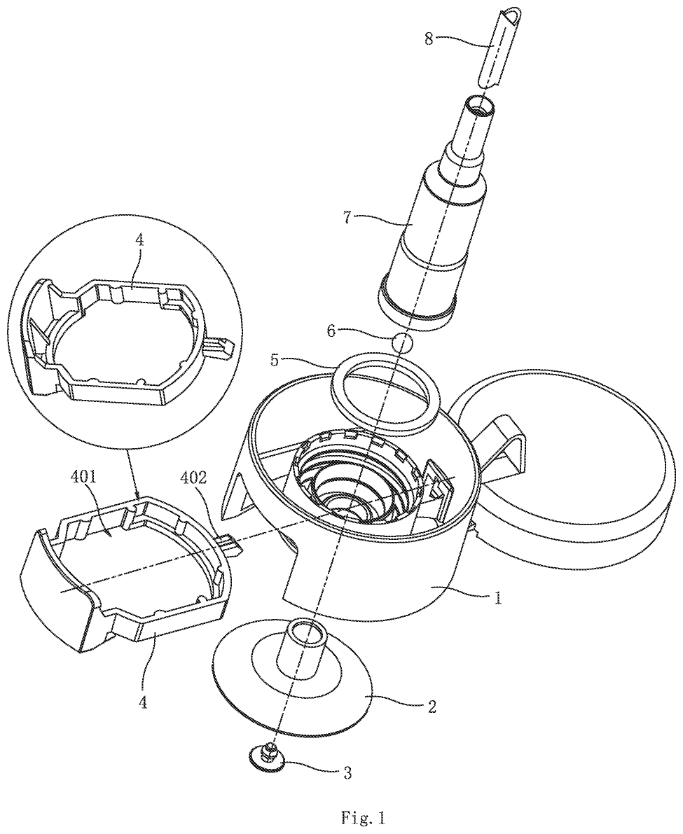

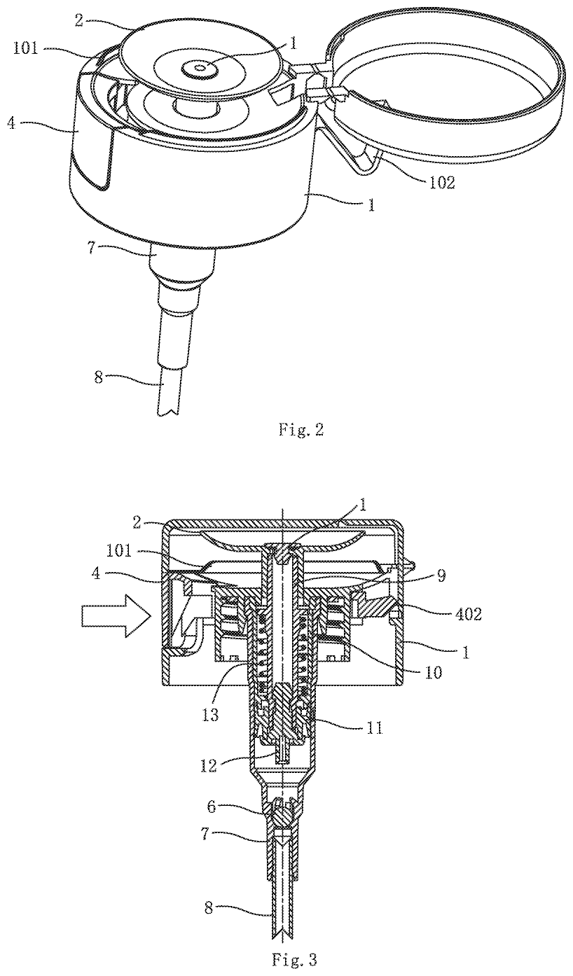

The structure of the invention is further described with reference to the accompanying drawings. As shown in the first embodiment of FIGS. 1-3, an inner threaded ring is provided at the bottom of the bottle cap 1, a pump outlet ring is disposed on the inner side of the inner threaded ring of the bottle pump, a clasp of the pump body 7 is fixed to the pump outlet ring of the pump body, the stem 9 extending from the pump body is snap-fit to the stem sleeve disposed at the bottom of the pressing plate cap 2, an anti-release plug 3 is disposed on the orifice at the top of the pressing plate cap, liquid flows out through the orifice at the anti-release plug disposed on top of the pressure plate cap, the pump core assembly comprises the pump body, the stem, the plastic ball bead 6, the inner plug 10, the piston 11, the valve pin 12 and the spring 13. The specific structure is described as follows: the top sides of the bottle cap are symmetrically provided with protruded snap-in edges 101, the button slot on one side of the cap between the snap-in edges is provided with a button 4, the snap-in edges of the cap are snapped to the corresponding rim edge of the flip cover, the cap on the other symmetrical side of the button is provided with a flip cover hingedly fixed to the bottle cap, an elastic strip 102 is disposed between the flip cover and the bottle cap at the hinged joint, and both ends of the elastic strip are molded in one piece with the bottle cap and the flip cover of the bottle cap respectively; the elastic hole 401 of the button passes through the outer diameter of the inner threaded ring at the bottom of the bottle cap, with one end of the button fit into the button slot on one side of the bottle cap, and the elastic contact 402 of the other end extended from the button slot and symmetrical with respect to the opening slot of the bottle cap, where the elastic slot of the button is aligned with the elastic strip; the elastic hole of the button is larger than the outer diameter of the inner threaded ring of the bottle cap, the elastic contact of the button is set against the elastic strip of the bottle cap, and the flip of the bottle cap pops open.

Disconnected strap ribs are disposed on both sides of the opening slot where flip cover of the bottle cap is hinged and fixed, the flip cover that is symmetrical to the opening slot is provided with an opening side slot, both ends of the elastic strip of the bottle cap are molded in one piece with the bottle cap and the flip cover of the bottle cap through the bottom of the opening slot, the bottom of the side slot respectively, and the strap ribs are molded in one piece with the bottle cap. The button is provided with equally spaced protruded ribs inside the elastic hole of the button, a protruded locating rib is disposed in the middle on top of the elastic contact of the button, the upper and lower edges of the curved side of the button symmetrically on the other side of the elastic contact are protruded above the elastic hole of the button respectively, the locating rib at the elastic contact of the button is inserted into the locating slot at the opening groove. The outer diameter of the plug gap on top of the inner plug is fastened to the inner diameter of the pump outlet of the pump body, the metal spring is disposed on the inner side of the inner plug with one end set against the bottom of the spring cavity in the inner plug, and the other end set against the spring rib of the outer diameter of the stem. The stem has one end extended from the inner plug and the pump body and the other end fastened in one-piece to the valve pin in the pump body, a piston is disposed at the snap-in joint, the stem and the pin at the snap-in joint are disposed with accessible liquid pathways respectively, the outer diameter of the piston sealed against the inner wall of the pump body, a plastic ball bead is fastened to the inlet hole of the pump body underneath the valve pin, and a dip tube 8 is inserted at the bottom of the inner hole of the pump body.

When pushing down, the button would be subject to deformation or displacement, such that the elastic contact of the button has one end set against the elastic strip disposed between the flip cover and the bottle cap, the snap-in position between the flip cover and the bottle cap is forced to displace or disengage, the flip cover can pop open from the bottle cap. At this point, pushing down the pressing plate cap and the liquid will flow out of the pressing plate cap for use.

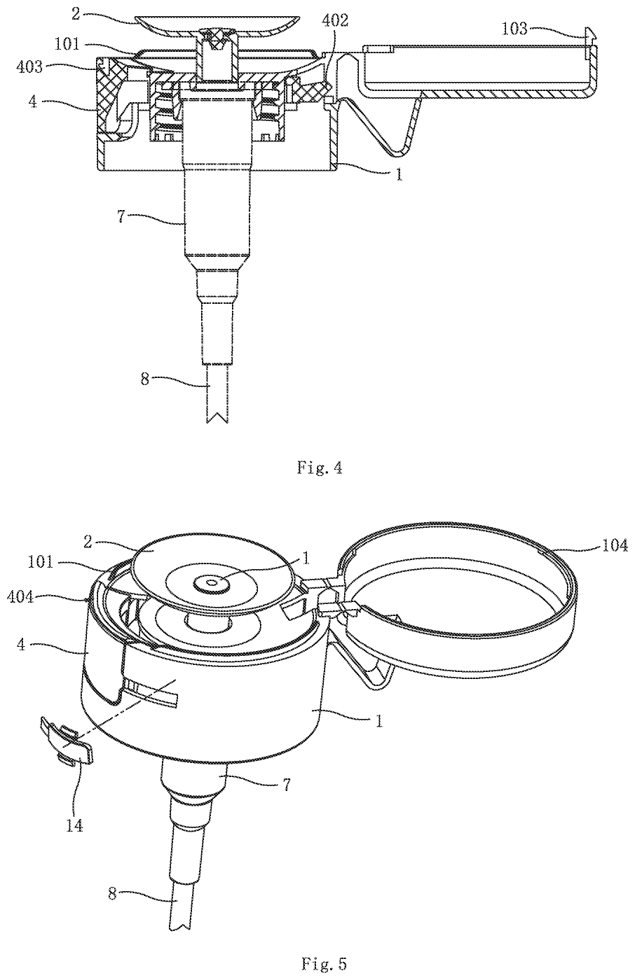

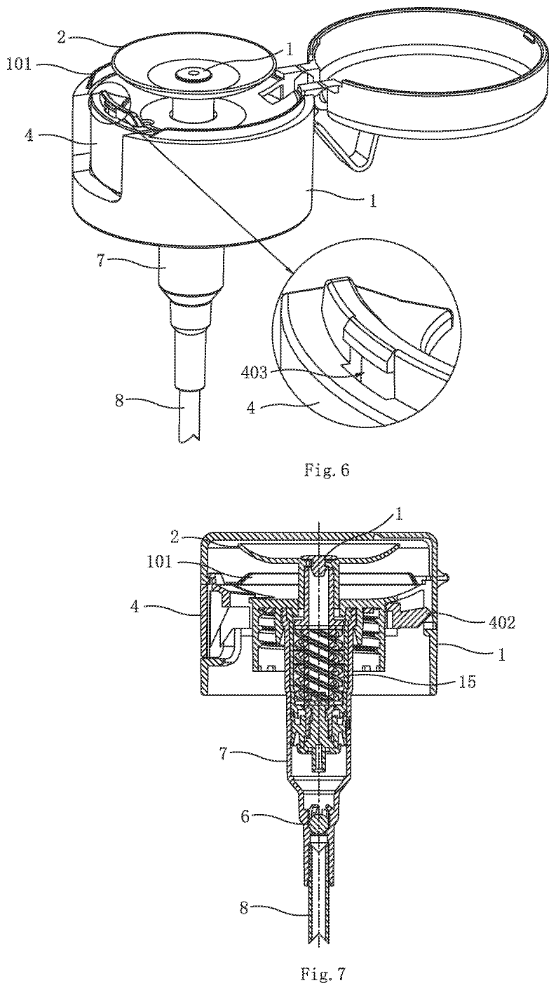

Referring to the structural features of the first embodiment as described above, the makeup remover pump head may also be structurally modified as follows: as shown in the second embodiment of FIG. 4, a clasp hole 403 is disposed on top of the button, the opening inside the flip cover of the bottle cap to which the clasp hole corresponds is provided with a snap-in clasp 103, and the snap-in clasp of the flip cover engages with the snap-in hole of the button. as shown in the third embodiment of FIG. 5, a protruded snap-in lip 404 is disposed on top of the button, the snap-in lip transits from bottom to the outer side of the top which is protruded and molded in one piece, the opening inside the flip cover of the bottle cap to which the protruded snap-in lip corresponds is provided with a protruded snap-in rib 104, the snap-in rib of the flip cover engages with the snap-in lip of the button. A locking knob 14 is disposed at the button slot side of the bottle cap, the slide hooks on the upper and lower edges of the locking knob are fastened to the slide slot on the button slot side of the bottle cap, and the locking head on the locking knob side is inserted into the locking hole on the button side of the bottle cap. As shown in the fourth embodiment of FIGS. 6 and 7, the snap-in lip of the button is provided with the clasp hole, a lower clasp is disposed on the edge of the snap-in lip above the clasp hole, the opening inside the flip cover of the bottle cap to which the lower clasp corresponds is provided with the upper clasp, and the upper clasp of the flip cover engages with the clasp hole of the button, the metal spring is replaced by a spiral one-piece plastic spring. The push-down button as a part of the above structure can also drive the pop opening of the flip cover from the bottle cover, the locking knob prevents the accidental push-down of the button, and the above structure facilitates the overall recycling and reuse of the makeup remover pump head.

1. A one-touch makeup remover pump head, an inner threaded ring is provided at the bottom of the bottle cap, a pump outlet ring is disposed on the inner side of the inner threaded ring of the bottle pump, a clasp of the pump body is fixed to the pump outlet ring of the pump body, the stem extending from the pump body is snap-fit to the stem sleeve disposed at the bottom of the pressing plate cap, an anti-release plug is disposed on the orifice at the top of the pressing plate cap, liquid flows out through the orifice at the anti-release plug disposed on top of the pressure plate cap, the pump core assembly comprises the pump body, the stem, the plastic ball bead, the inner plug, the piston, the valve pin and the spring; wherein the top sides of the bottle cap are symmetrically provided with protruded snap-in edges, the button slot on one side of the cap between the snap-in edges is provided with a button, the snap-in edges of the cap are snapped to the corresponding rim edge of the flip cover, the cap on the other symmetrical side of the button is provided with a flip cover hingedly fixed to the bottle cap, an elastic strip is disposed between the flip cover and the bottle cap at the hinged joint, and both ends of the elastic strip are molded in one piece with the bottle cap and the flip cover of the bottle cap respectively; the elastic hole of the button passes through the outer diameter of the inner threaded ring at the bottom of the bottle cap, with one end of the button fit into the button slot on one side of the bottle cap, and the elastic contact of the other end extended from the button slot and symmetrical with respect to the opening slot of the bottle cap, where the elastic slot of the button is symmetrical with respect to the elastic strip; the elastic hole of the button is larger than the outer diameter of the inner threaded ring of the bottle cap, the elastic contact of the button is set against the elastic strip of the bottle cap, and the flip of the bottle cap pops open.

2. A one-touch makeup remover pump head according to claim 1, wherein disconnected strap ribs are disposed on both sides of the opening slot where flip cover of the bottle cap is hinged and fixed, the flip cover that is symmetrical to the opening slot is provided with an opening side slot, both ends of the elastic strip of the bottle cap are molded in one piece with the bottle cap and the flip cover of the bottle cap through the bottom of the opening slot, the bottom of the side slot respectively, and the strap ribs are molded in one piece with the bottle cap.

3. A one-touch makeup remover pump head according to claim 1, wherein the button is provided with equally spaced protruded ribs inside the elastic hole of the button, a protruded locating rib is disposed in the middle on top of the elastic contact of the button, the upper and lower edges of the curved side of the button symmetrically on the other side of the elastic contact are protruded above the elastic hole of the button respectively, the locating rib at the elastic contact of the button is inserted into the locating slot at the opening groove.

4. A one-touch makeup remover pump head according to claim 1, wherein a clasp hole is disposed on top of the button, the opening inside the flip cover of the bottle cap to which the clasp hole corresponds is provided with a snap-in clasp, and the snap-in clasp of the flip cover engages with the snap-in hole of the button.

5. A one-touch makeup remover pump head according to claim 1, wherein a protruded snap-in lip is disposed on top of the button, the snap-in lip transits from bottom to the outer side of the top which is protruded and molded in one piece, the opening inside the flip cover of the bottle cap to which the protruded snap-in lip corresponds is provided with a protruded snap-in rib, the snap-in rib of the flip cover engages with the snap-in lip of the button.

6. A one-touch makeup remover pump head according to claim 5, wherein the snap-in lip of the button is provided with the clasp hole, a lower clasp is disposed on the edge of the snap-in lip above the clasp hole, the opening inside the flip cover of the bottle cap to which the lower clasp corresponds is provided with the upper clasp, and the upper clasp of the flip cover engages with the clasp hole of the button.

7. A one-touch makeup remover pump head according to claim 1, wherein a locking knob is disposed at the button slot side of the bottle cap, the slide hooks on the upper and lower edges of the locking knob are fastened to the slide slot on the button slot side of the bottle cap, and the locking head on the locking knob side is inserted into the locking hole on the button side of the bottle cap.

8. A one-touch makeup remover pump head according to claim 1, wherein the spring in the pump body is a metal spring, the outer diameter of the plug gap on top of the inner plug is fastened to the inner diameter of the pump outlet of the pump body, the metal spring is disposed on the inner side of the inner plug with one end set against the bottom of the spring cavity in the inner plug, and the other end set against the spring rib of the outer diameter of the stem. The stem has one end extended from the inner plug and the pump body and the other end fastened in one-piece to the valve pin in the pump body, a piston is disposed at the snap-in joint, the stem and the pin at the snap-in joint are disposed with accessible liquid pathways respectively, the outer diameter of the piston sealed against the inner wall of the pump body, a plastic ball bead is fastened to the inlet hole of the pump body underneath the valve pin, and a dip tube is inserted at the bottom of the inner hole of the pump body. The particular structural embodiment of the pump core assembly is described above.

9. A one-touch makeup remover pump head according to claim 8, wherein the metal spring is replaced by a spiral one-piece plastic spring.
